(19) United States
(12) Patent Application Publication
(10) Pub. No.: US 2009/0229675 A1
(43) Pub. Date: Sep. 17, 2009

(54) IN-LINE FILTER/FLOW REGULATOR/ANTI-SIPHON DEVICE

(76) Inventors: Scot Hoskisson, Layton, UT (US); Tres Wangsgaard, Holladay, UT (US)

Correspondence Address: MADSON IP, Old Shepard Commons, Suite 230, 1466 North Highway 89, Farmington, UT, 84025, US

(21) Appl. No.: 12/049,733

(22) Filed: Mar. 17, 2008

(51) Int. Cl. F16K 24/00

(52) U.S. Cl. 137/215

(57) ABSTRACT

An in-line, hose-end filter/flow regulator/anti-siphon device is disclosed. The disclosed hose-end device includes a unitary body having a generally linear side profile, a first end, a second end, and a longitudinal axis. An inlet hose-end receptor is disposed on the first end, while an outlet hose-end receptor is disposed on the second end. An anti-siphon section, a filter section, and a flow regulator section are positioned between the first end and the second end. The inlet hose-end receptor, the anti-siphon section, the filter section, the flow regulator section, and the outlet hose-end receptor are coaxial with the longitudinal axis of the body.

### BACKGROUND OF THE INVENTION

Distributing fluid through a hose can create a host of different problems. For example, contaminants within the hose can backflow into a water source, polluting the water source (such as the water supply of a house).

Also, filtering fluid within a hose can be important to protect hose nozzles, hose-end sprinklers, and other hose-end products from becoming clogged due to debris within the hose. Furthermore, fluid distributed via a hose can often have uneven water pressure, particularly when the fluid is initially turned on, causing sprinklers and hose nozzles attached to the hose to perform erratically.

Addressing each of these problems independently would require a cumbersome and awkward conglomeration of devices, making it very difficult to utilize the devices together. Further, assembling a number of different devices to address these problems could be expensive, and the operation of one of these devices may interfere with the operation of the other devices.

Accordingly, an integrated solution that is compact and streamlined is desirable.

### BRIEF SUMMARY OF THE INVENTION

An in-line, hose-end anti-siphon/filter/flow regulator device that addresses these problems is disclosed. This device uses a unitary, or integral, body that may be positioned between a fluid source and a fluid component. This hose-end device is streamlined and compact, having a generally linear side profile—without large protrusions or extensions that could easily be broken off or subjected to severe blows during normal operation.

The unitary body includes a first end, a second end, and a longitudinal axis. The device further includes an inlet hose-end receptor that may be coupled to a mating interface from a fluid source and an outlet hose-end receptor that may be coupled to a fluid component. The inlet hose-end receptor is disposed on the first end of the device, while the outlet hose-end receptor is disposed on the second end of the hose-end device, making the device an “in-line” device.

In one embodiment, the inlet hose-end receptor includes female threads for receiving a mating interface from a fluid source. Similarly, the outlet hose-end receptor may include male threads for receiving mating female threads of a fluid component.

The device further includes an anti-siphon section, a filter section, and a flow regulator section, each of which are positioned between the first and the second end. The inlet hose-end receptor, the anti-siphon section, the filter section, the flow regulator section, and the hose-end receptor are coaxial with the longitudinal axis of the body. Further, the anti-siphon section, the filter section, and the flow regulator section are sequentially disposed along the longitudinal axis of the body, though the function of each section may slightly overlap with an adjacent section making the device more compact than a connection of individual components. The body also defines a flow path in which fluid flows through the anti-siphon section, the filter section, and the flow regulator section.

In one embodiment, the anti-siphon section, the filter section, and the flow regulator section are in immediately adjacent positions. This means that there are no intervening connectors between each of these sections, regardless of the order in which these sections are arranged.

The anti-siphon section includes an anti-siphon opening defined by an inlet hose-end cap. An anti-siphon seal surrounds the anti-siphon opening. An anti-siphon plunger includes a head and an arm. The anti-siphon plunger is biased by an anti-siphon spring, such that the head of the anti-siphon plunger abuts the anti-siphon seal to close the anti-siphon opening. When the incoming fluid force is sufficient to overcome the biasing effect of the spring, fluid passes through the opening and through the hose-end device. When the incoming fluid force is insufficient to overcome this biasing effect, the anti-siphon plunger prevents fluid from “backflowing” and potentially contaminating the fluid source from which the incoming fluid originated.

The filter section comprises a filter chamber defining one or more openings for fluid entry and one or more openings for fluid exit. It further includes a mesh filter disposed within the filter chamber. The filter may utilize stainless steel mesh webbing and may be self cleaning.

The flow regulator section includes a flow regulator piston disposed within a flow regulator chamber. The flow regulator piston has a narrow region, a frusto-conical region, an external groove, and a pressure lip. The flow regulator chamber defines one or more openings for fluid entry disposed proximate the narrow region of the flow regulator piston. A flow regulator spring biases the flow regulator piston in an open state. When the fluid flows through the flow regulator section, the flow regulator piston applies sufficient pressure to the pressure lip to counterbalance the biasing effect of the flow regulator spring, thus the flow regulator piston is pushed towards a closed state, at least partially blocking the opening for fluid entry to the flow chamber and decreasing fluid flow and pressure within the flow regulator section. Alternatively, if the fluid pressure within the flow regulator section decreases, the piston moves further towards an open state, widening the opening for fluid entry and allowing more fluid to pass through the flow regulator section. The flow regulator piston thus regulates the flow of fluid through the hose-end device.

### BRIEF DESCRIPTION OF THE SEVERAL VIEWS OF THE DRAWINGS

In order that the manner in which the above-recited and other features and advantages of the invention are readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a side perspective, exploded view of one embodiment of an in-line hose-end filter/flow regulator/anti-siphon device shown together with the embodiments of a fluid source and a fluid component;

FIG. 2 is a cross-sectional view of the embodiment of the in-line hose-end device of FIG. 1 displaying a longitudinal axis of a unitary body thereof;

FIG. 3 is a cross-sectional view of the embodiment of FIG. 1 illustrating a path through which fluid may flow through the device;

FIG. 4A is a exploded view of the hose-end device of FIG. 1;

FIG. 4B is an exploded, cross-sectional view of the hose-end device of FIG. 1;

FIGS. 5A and 5B are cross-sectional views of an anti-siphon portion of the hose-end device in a closed and open state, respectively;

FIGS. 6 is a cross-sectional view of a filter section of the hose-end device of FIG. 1; and

FIGS. 7A, 7B, and 7C are cross-sectional views of a flow regulator section of the device of FIG. 1 shown in an open, partially closed, and closed state, respectively.

### DETAILED DESCRIPTION OF THE INVENTION

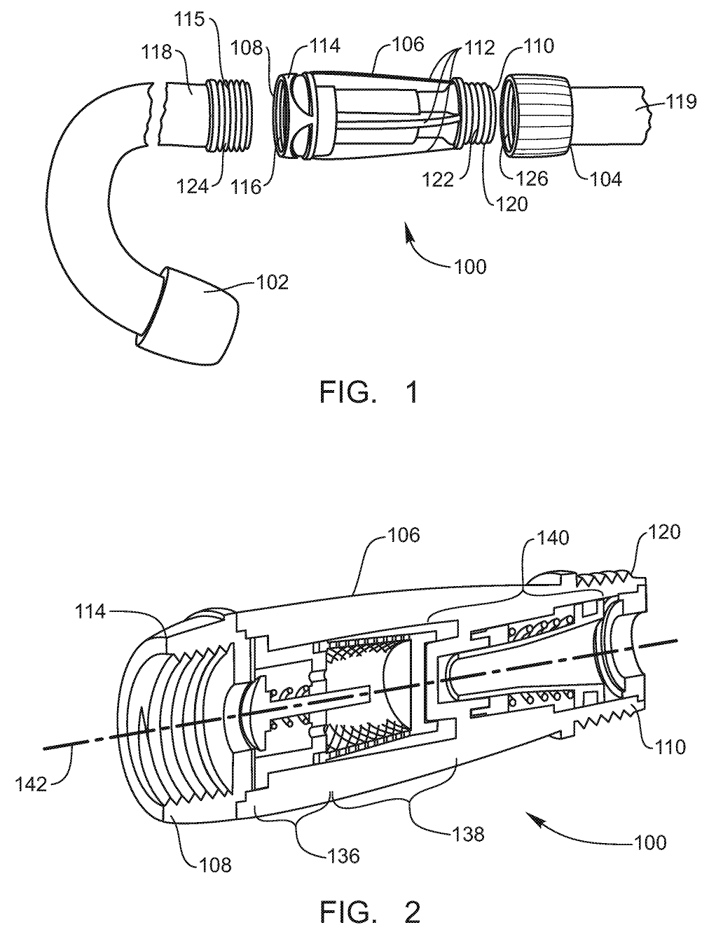

The presently preferred embodiments of the invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in FIGS. 1 through 8, is not intended to limit the scope of the invention, as claimed, but is merely representative of presently preferred embodiments of the invention.

As used herein, the term “in fluid communication with” means that fluid, if present, could pass from a first identified fluid passageway, object, opening, or aperture to a second fluid passageway, object, opening, or aperture. This term does not require that fluid be actually present within any of the identified fluid passageways, objects, openings, or apertures.

FIG. 1 is a side, exploded perspective view of one embodiment of an in-line hose-end filter/flow regulator/anti-siphon device 100. FIG. 1 also illustrates embodiments of a fluid source 102 and a fluid component 104.

As shown in FIG. 1, the hose-end device 100 includes a unitary, or integral, body 106 that has a generally linear side profile. The unitary body 106 is a single integral component, although it may comprise multiple components fused, secured, or welded (e.g., sonic welded) together. The in-line hose-end device 100 also includes a first end 108 and a second end 110.

The unitary body 106 includes a series of support ribs 112. The support ribs 112 strengthen the device 100 against warping or undesirable bending or lateral flexing without the need to utilize additional material. The unitary body 106 may be made, for example, from a polymer-based material (such as Acrylonitrile-butadiene-styrene terpolymer (ABS)), a metallic material, or any other suitable material.

The first end 108 of the device 100 includes an inlet hose-end receptor 114. The inlet hose-end receptor 114 may be embodied in a number of different ways, such as female threads 116 or a quick coupling interface (not shown), which is known to those of skill in the industry. The inlet hose-end receptor 114 receives a mating interface 115 from a fluid source 102. The fluid source 102 could be coupled to the device 100 in a number of different ways. For example, the device 100 could be in fluid communication with the fluid source 102 via a hose 118, as illustrated in FIG. 1, or a spigot (not shown).

The device 100 also includes an outlet hose-end receptor 120, and could include male threads 122 or a quick connect interface (not shown). As explained in connection with the inlet hose-end receptor 114, the outlet hose-end receptor 120 may be embodied in a number of different ways. The outlet hose-end receptor 120 may interface with any type of fluid component 104, such as a hose 119, a hose nozzle, or a sprinkler.

As shown in the illustrated embodiment, the inlet hose-end receptor 114 includes female threads 116 for receiving mating male threads 124 from a fluid source 102. In contrast, the outlet hose-end receptor 120 includes male threads 122 for receiving mating female threads 126 of a fluid component 104.

FIG. 2 is a cross-sectional view of the embodiment of the hose-end device 100 shown in FIG. 1. The illustrated embodiment includes the unitary body 106, the inlet hose-end receptor 114, an anti-siphon section 136, a filter section 138, a flow regulator section 140, and the outlet hose-end receptor 120. The body includes a longitudinal axis 142. The anti-siphon section 136, filter section 138, and flow regulator section 140 will be described in greater detail in connection with subsequent figures.

As illustrated in FIG. 2, the inlet hose-end receptor 114, the anti-siphon section 136, the filter section 138, the flow regulator section 140, and the outlet hose-end receptor 120 are coaxial with the longitudinal axis 142 of the body 106. This configuration makes the device 100 streamlined, enabling it to be utilized without adding unnecessary bulk to a fluid line. This streamlined configuration also makes it less likely that the device 100 will be broken or damaged in that there are no bulky outwardly projecting parts that could be broken off or easily subjected to heavy blows during normal usage.

The inlet hose-end receptor 114 is disposed on the first end 108 of the unitary body 106. The outlet hose-end receptor 120, in contrast, is disposed on the second end 110 of the unitary body 106. As shown in FIG. 2, the anti-siphon section 136, the filter section 138, and the flow regulator section 140 are sequentially disposed along the longitudinal axis 142 of the body 106.

In the illustrated embodiment, the anti-siphon section 136, the filter section 138, and the flow regulator section 140 are in immediately adjacent positions. This means that these sections 136, 138, 140 are adjacent to each other without intervening connectors (e.g., threaded interfaces). Further, the function of each section 136, 138, 140 may slightly overlap with an adjacent section 136, 138, 140 (for example, a portion of the anti-siphon plunger 154 may move within the filter section 138) making the device 100 more compact than a connection of individual components.

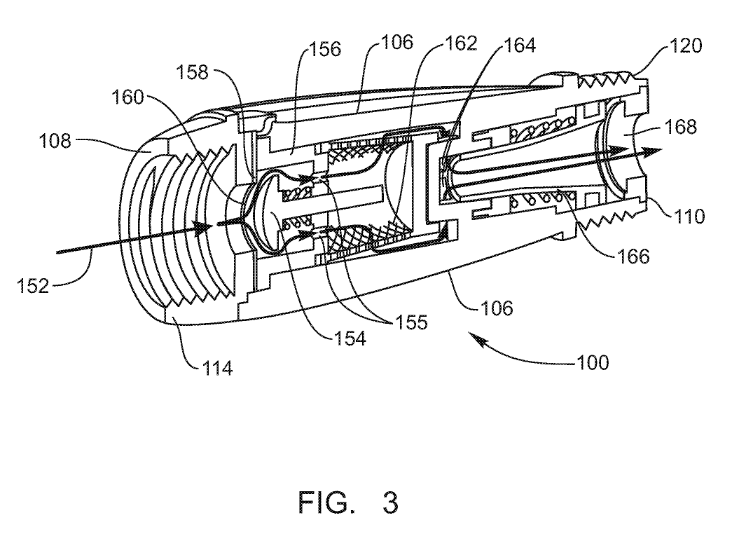

FIG. 3, like FIG. 2, is a cross-sectional view of the embodiment of the in-line hose-end filter/flow regulator/anti-siphon device 100 shown in FIG. 1. The embodiment of FIG. 3 illustrates a flow path 152 with arrows by which fluid may flow through the device 100. Fluid initially enters the device 100 via the inlet hose-end receptor 114 on the first end 108 of the device 100. Fluid passes around an anti-siphon plunger 154, when the plunger 154 is in an open state, and through openings 155 in an anti-siphon cup 156. Of course, if the anti-siphon plunger 154 is in a closed state, fluid will be precluded from passing the point at which the anti-siphon plunger 154 contacts an anti-siphon seal 158 surrounding an anti-siphon opening 160.

Thereafter, the fluid passes through a filter 162, which may be self-cleaning filter 162. After passing through the filter 162, fluid proceeds into openings 164 formed in the body 106 of the device 100 so long as the anti-siphon plunger 154 is not in the closed position. The fluid then passes through the flow regulator piston 166 and out of the end cap 168, simultaneously passing through the outlet hose-end receptor 120 disposed on the second end 110 of the device 100.

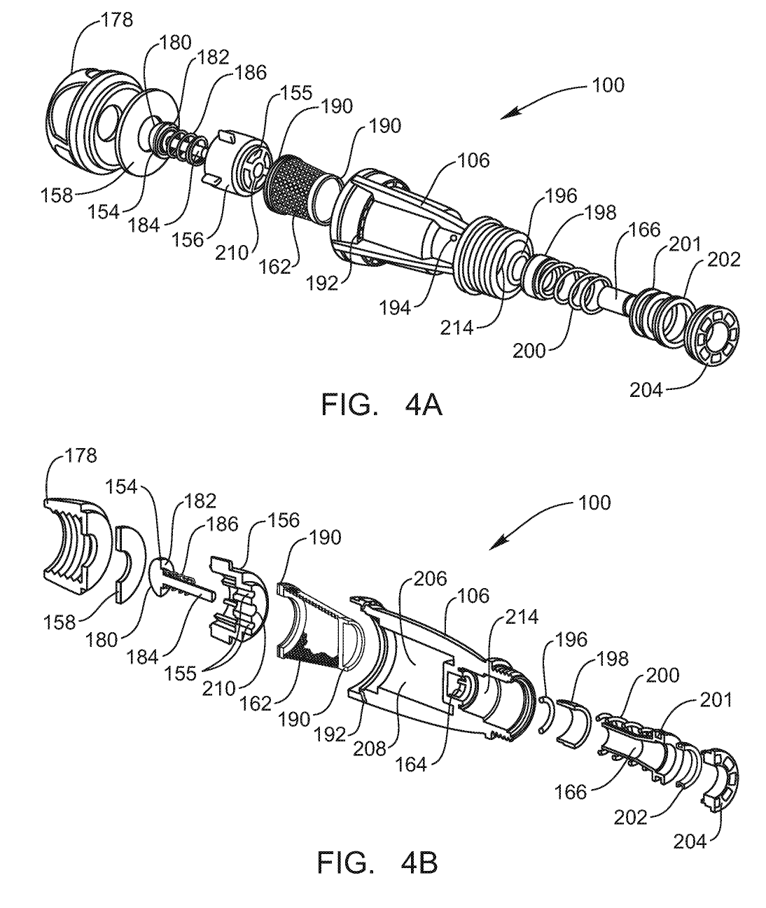

FIG. 4A is an exploded view of the embodiment of the hose-end device 100 shown in FIG. 1, while FIG. 4B is an exploded sectional view of the hose-end device 100. With reference to both of these figures, the device 100 includes an inlet hose-end cap 178, the anti-siphon seal 158, the anti-siphon plunger 154 with a head having a dome-shaped side 180 and a flat side 182 and an arm 184, an anti-siphon spring 186, and an anti-siphon cup 156. The anti-siphon cup 156 includes openings 155 through which fluid may pass when the anti-siphon plunger 154 is in an open position.

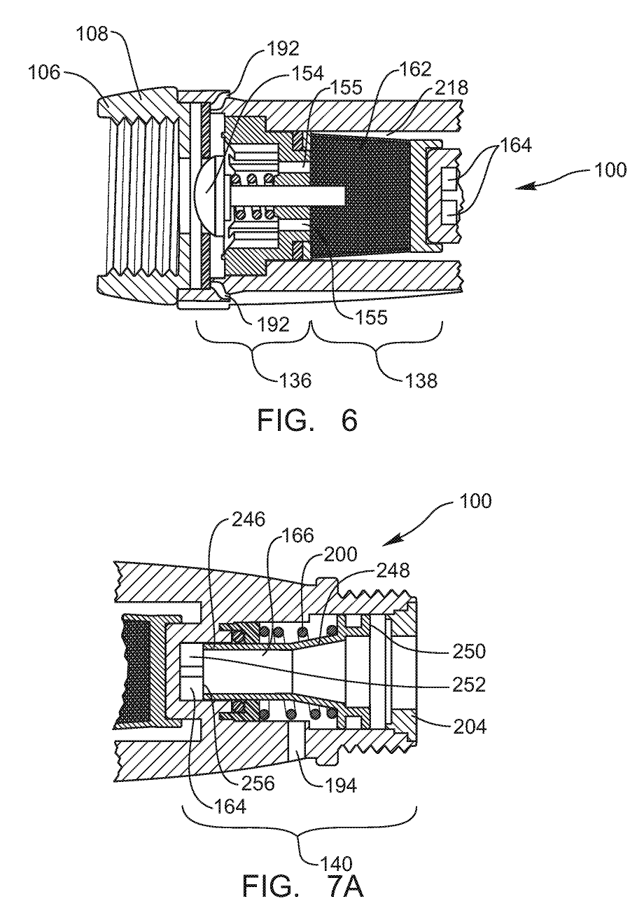

The device 100 also includes a filter 162. In one embodiment, the filter 162 is made from a stainless steel mesh. The filter 162 may include seals 190 on each end of the filter 162 such that fluid cannot circumvent the filter 162. As indicated above, the filter 162 may be self-cleaning. The self-cleaning feature of the filter 162 will be explained in connection with FIG. 6.

The body 106 includes one or more anti-siphon vents 192 and flow regulator vents 194. The purpose of the vents 192, 194 will be discussed below.

The device also includes a flow regulator 0-ring seal 196, a flow regulator retainer 198, a flow regulator spring 200, a flow regulator piston 166, a flow regulator U-cup seal 202, and an end cap 204.

The hose-end device 100 may be assembled in the following manner. The filter 162 is positioned on the anti-siphon cup 156. The anti-siphon cup 156 with the filter 162 is inserted and secured (e.g., sonic welded, press fit, or threaded into) into an anti-siphon recess 208 and a filter recess 206. The arm 184 of the anti-siphon plunger 154 is inserted through an opening 210 in the anti-siphon cup 156 with the anti-siphon spring 186 surrounding the arm 184 of the anti-siphon plunger 154. The anti-siphon seal 158 is positioned to engage the anti-siphon plunger 154 in a sealing relationship. The inlet hose-end cap 178 is secured to the unitary body 106 to retain the anti-siphon plunger 154 and anti-siphon seal 158 within the anti-siphon recess 208.

The flow regulator O-ring seal 196 is placed on the flow regulator retainer 198. The flow regulator retainer 198 with the flow regulator O-ring seal 196 is inserted into the flow regulator recess 214. A flow regulator U-cup seal 202 is positioned into an external, annular groove 201 on a flow regulator piston 166. A flow regulator spring 200 and the flow regulator piston 166 with the flow regulator U-cup seal 202 are inserted into the flow regulator recess 214. An outlet end cap 204 is secured to the unitary body 106 to retain the flow regulator spring 200 and the flow regulator 216 with the flow regulator U-cup seal 202 within the flow regulator recess 214.

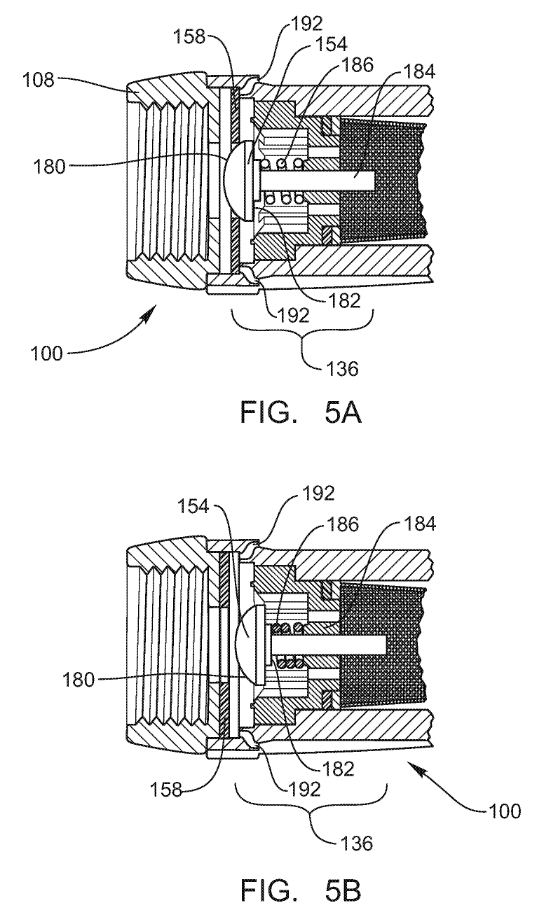

FIGS. 5A and 5B illustrate a sectional view of the anti-siphon section 136 of the hose-end device 100. FIG. 5A illustrates the anti-siphon plunger 154 in a closed state, while FIG. 5B illustrates the anti-siphon plunger 154 in an open state.

As shown in FIG. 5A, the anti-siphon spring 186 is disposed about the arm 184 and biases the anti-siphon plunger 154 in a closed state. In this closed state, the anti-siphon plunger 154 abuts the anti-siphon seal 158 preventing fluid from flowing through the device 100 toward the first end 108 of the device 100. In this state, pressure within the anti-siphon section 136 will exert a force on the flat side of the head 182, more securely pressing the anti-siphon plunger 154 into the anti-siphon seal 158. The anti-siphon plunger 154 thus decreases the possibility that contaminants in the fluid in the device 100 will flow toward and potentially contaminate the fluid source (as shown in FIG. 1), such as culinary water supply in fluid communication with the device 100.

FIG. 5B shows the anti-siphon plunger 154 in an open state. As fluid enters the device 100 from the fluid source (as shown in FIG. 1), the pressure of the fluid exerts a force on the dome shaped side 180 of the head and counteracts the biasing effect of the anti-siphon spring 186. This enables fluid to pass through a gap created between the anti-siphon plunger 154 and the anti-siphon seal 158.

When the pressure of the fluid entering the device 100 is insufficient to counteract the biasing effect of the anti-siphon plunger 154, the anti-siphon plunger 154 moves back into the closed position, preventing fluid from moving past the anti-siphon plunger 154, as shown in FIG. 5A.

FIG. 6 is a cross-sectional view of the filter section 138 (with the anti-siphon plunger 154 shown in a closed state). The filter section 138 includes a filter chamber 218 defining one or more openings 155 for fluid entry and one or more openings 164 for fluid exit, and a filter 162 disposed within the chamber 218. The filter 162 captures debris within the fluid and prevents the captured debris from exiting the device 100 through the outlet hose-end receptor 114 (shown in FIG. 1). In one embodiment, the filter 162 may comprise stainless steel mesh webbing.

As indicated above, the filter 162 may be self-cleaning. The self-cleaning operation is performed in the following manner. When the anti-siphon plunger 154 is in an open state, the anti-siphon seal 158 is positioned toward the filter 162 and blocks the anti-siphon vents 192. As the downstream pressure becomes greater than the upstream pressure, the anti-siphon plunger 154 proceeds into a closed state, as illustrated in FIG. 6. The anti-siphon seal 158 is repositioned toward the first end 108 of the device 100 such that the anti-siphon seal 158 no longer obstructs the anti-siphon vents 192.

Closure of the anti-siphon plunger 154 creates a pressure spike within the device 100. The pressure spike within the device 100 pushes fluid and debris within the filter 162 downstream of the filter 162 exiting out of the device 100 through the anti-siphon vents 192 shown on the body 106. As such, the contaminants in the filter 162 are pushed out of the filter 162, effectively cleaning the filter 162. This cleaning action will take place each time the anti-siphon plunger 154 is transitioned from an open state to a closed state, i.e., when fluid pressure from the fluid source (not shown) is insufficient to maintain the anti-siphon plunger 154 in an open state.

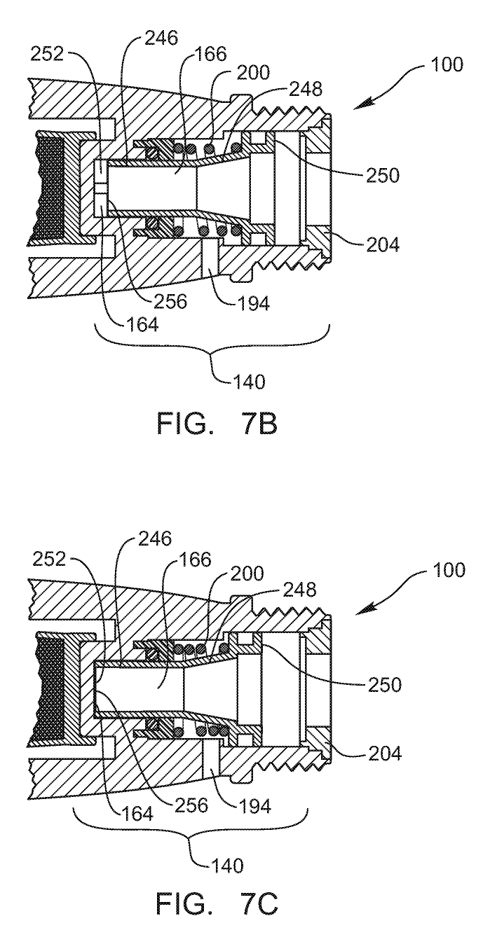

FIGS. 7A, 7B, and 7C are cross-sectional views of the flow regulator section 140 of the device 100 of FIG. 1 shown in different states. In particular, in FIG. 7A shows the flow regulator piston 166 in an open state; FIG. 7B shows the flow regulator piston 166 in a partially closed state; and FIG. 7C illustrates the flow regulator piston 166 in a closed state.

With respect to FIGS. 7A-C the flow regulator piston 166 includes a narrow region 246, a frusto-conical region 248, and a pressure lip 250. A flow regulator chamber 252 defines one or more openings 164 for fluid entry. The openings 164 are disposed proximate the narrow region 246 of the flow regulator piston 166. The flow-regulator spring 200 biases the flow regulator piston 166 in an open state. The flow regulator vent 194 enables atmospheric gas to pass through the vent 194 as the flow regulator piston 166 changes position.

With respect to FIG. 7A, the flow regulator piston 166 is in an open state. In this state, the flow regulator piston 166 is in its closest position to the end cap 204, within its range of motion. Fluid passes through the openings 164 for fluid entry into the flow regulator piston 166 and exits out of the device 100 through the end cap 204.

With respect to FIG. 7B, when the flow of fluid through the flow regulator section 140 achieves a sufficient pressure, pressure is exerted on the pressure lip 250 of the flow regulator piston 166. This pressure results from the greater surface area of the pressure lip 250 (applying greater “closing” pressure) relative to opposing surfaces on the flow regulator piston 166 (such as the narrow lip 256 on the narrow region 246 of the flow regulator piston 166). This pressure counters the biasing effect of the flow regulator spring 254, driving the flow regulator piston 166 toward a closed state and at least partially occluding the openings 164 for fluid entry, as shown in FIG. 7B. The partial occlusion of the openings 164 for fluid entry thus decreases fluid flow through the flow regulator piston 166, causing the flow regulator piston 166 to shift toward an open state. The position of the flow regulator piston 166 will thus change in response to pressure within the device 100 to “regulate” the flow of fluid through the device 100.

If pressure flowing through the device 100 achieves a sufficient level, the flow regulator piston 166 may be driven to a fully closed state, as shown in FIG. 7C. Of course, this would only occur for a brief period of time, because fully closing the openings 164 for fluid entry would effectively stop fluid flow through the device 100 and at least dramatically reduce the pressure of fluid within the flow regulator section 140. In response to this reduction in pressure, the pressure applied to the pressure lip 250 would decrease and the flow regulator spring 254 would bias the flow regulator piston 166 toward an open state, allowing fluid to pass through the openings 164 for fluid entry again.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An in-line hose-end filter/flow regulator/anti-siphon device comprising:
a unitary body having a generally linear side profile, a first end, a second end, and a longitudinal axis;
an inlet hose-end receptor disposed on the first end;
an outlet hose-end receptor disposed on the second end;
an anti-siphon section positioned between the first end and the second end;
a filter section positioned between the first end and the second end; and
a flow regulator section positioned between the first end and the second end, wherein the inlet hose-end receptor, the anti-siphon section, the filter section, the flow regulator section, and the outlet hose-end receptor are coaxial with the longitudinal axis of the body.

2. The in-line hose-end device of claim 1, wherein the anti-siphon section, the filter section, and the flow regulator section are sequentially disposed along the longitudinal axis of the body.

3. The in-line hose-end device of claim 1, wherein the body defines a flow path in which fluid may flow through the anti-siphon section, the filter section, and the flow regulator section, and wherein the anti-siphon section allows fluid to flow generally in one direction.

4. The in-line hose-end device of claim 1, wherein the inlet hose-end receptor includes threads for receiving a mating interface from a fluid source.

5. The in-line hose-end device of claim 1, wherein the outlet hose-end receptor includes threads for receiving mating threads of a fluid component.

6. The in-line hose-end device of claim 1, wherein the body further comprises support ribs.

7. The in-line hose-end device of claim 1, wherein an anti-siphon section comprises:
an anti-siphon opening defined by an inlet hose-end cap;
an anti-siphon seal that surrounds the anti-siphon opening; and
an anti-siphon plunger biased by an anti-siphon spring to abut the anti-siphon seal to close the anti-siphon opening.

8. The in-line hose-end device of claim 1, wherein the filter section comprises:
a filter chamber defining at least one opening for fluid entry and at least one opening for fluid exit; and
a self-cleaning mesh filter disposed within the filter chamber.

9. The in-line hose-end device of claim 1, wherein a flow regulator section comprises:
a flow regulator piston disposed within a flow regulator chamber, the flow regulator piston having a narrow region, a frusto-conical region, an external, annular groove, and a pressure lip, the flow regulator chamber defining at least one opening for fluid entry disposed proximate the narrow region of the flow regulator piston; and
a flow regulator spring biasing the flow regulator piston in an open state, wherein when the fluid flowing through the flow regulator section applies sufficient pressure to the pressure lip to counterbalance the biasing effect of the flow regulator spring, the flow regulator piston is pushed towards a closed state to at least partially block the opening for fluid entry into the flow regulator chamber.

10. An in-line hose-end filter/flow regulator/anti-siphon device comprising:
unitary body having a generally linear side profile, a first end, a second end, and a longitudinal axis;
an inlet hose-end receptor disposed on the first end;
an outlet hose-end receptor disposed on the second end;
an anti-siphon section positioned between the first end and the second end;
a filter section positioned between the first end and the second end; and
a flow regulator section positioned between the first end and the second end, wherein the inlet hose-end receptor, the anti-siphon section, the filter section, the flow regulator section, and the outlet hose-end receptor are coaxial with the longitudinal axis of the body, and wherein the anti-siphon section, the filter section, and the flow regulator section are in immediately adjacent positions.

11. The in-line hose-end device of claim 10, wherein the anti-siphon section, the filter section, and the flow regulator section are sequentially disposed along the longitudinal axis of the body.

12. The in-line hose-end device of claim 10, wherein the body defines a flow path in which fluid may flow through the anti-siphon section, the filter section, and the flow regulator section, and wherein the anti-siphon section generally allows fluid to flow in only one direction.

13. The in-line hose-end device of claim 10, wherein the inlet hose-end receptor includes threads for receiving a mating interface from a fluid source.

14. The in-line hose-end device of claim 10, wherein the outlet hose-end receptor includes threads for receiving mating threads of a fluid component.

15. The in-line hose-end device of claim 10, wherein an anti-siphon section comprises:
an anti-siphon opening defined by an inlet hose-end cap;
an anti-siphon seal that surrounds the anti-siphon opening; and
an anti-siphon plunger biased by an anti-siphon spring to abut the anti-siphon seal to close the anti-siphon opening.

16. The in-line hose-end device of claim 10, wherein the filter section comprises:
a filter chamber defining at least one opening for fluid entry and at least one opening for fluid exit; and
a self-cleaning mesh filter disposed within the filter chamber.

17. The in-line hose-end device of claim 10, wherein a flow regulator section comprises:
a flow regulator piston disposed within a flow regulator chamber, the flow regulator piston having a narrow region, a frusto-conical region, an external, annular groove, and a pressure lip, the flow regulator chamber defining at least one opening for fluid entry disposed proximate the narrow region of the flow regulator piston; and
a flow regulator spring biasing the flow regulator piston in an open state, wherein when the fluid flowing through the flow regulator section applies sufficient pressure to the pressure lip to counterbalance the biasing effect of the flow regulator spring, the flow regulator piston is pushed towards a closed state to at least partially block the opening for fluid entry into the flow regulator chamber.

18. A method of manufacturing an in-line hose-end filter/flow regulator/anti-siphon device, the method comprising:
positioning a filter within a filter recess of a unitary body;
positioning and securing an anti-siphon within an anti-siphon recess of the unitary body; and
positioning and securing a flow regulator within flow regulator recess of the unitary body.

19. The method of claim 18, wherein positioning and securing the flow regulator within a flow regulator recess comprise:
placing a flow regulator O-ring seal on a flow regulator retainer;
inserting and securing the flow regulator retainer with the flow regulator O-ring seal within the flow regulator recess;
positioning a flow regulator U-cup seal into an external, annular groove on a flow regulator piston;
inserting a flow regulator spring and the flow regulator piston with the flow regulator U-cup seal into the flow regulator recess; and
securing an outlet end cap to the unitary body to secure the flow regulator spring and the flow regulator piston within the flow regulator recess.

20. The method of claim 18, wherein positioning the filter within the filter recess of a unitary body and positioning and securing an anti-siphon within an anti-siphon recess comprise:
positioning the filter on an anti-siphon cup;
inserting and securing the anti-siphon cup with the filter into the anti-siphon recess and filter recess, respectively;
inserting an arm of anti-siphon plunger through an opening in the anti-siphon cup with an anti-siphon spring surrounding the arm of the anti-siphon plunger;
positioning an anti-siphon seal on the anti-siphon plunger; and
securing inlet hose-end cap to the unitary body to retain the anti-siphon plunger and anti-siphon seal within the anti-siphon recess.
